(19) United States
(12) Patent Application Publication
(10) Pub. No.: US 2026/0029164 A1
(43) Pub. Date: Jan. 29, 2026

(54) SYSTEMS AND METHODS FOR PROTECTIVE SHADING STRUCTURES

(71) Applicant: THERMOSHADE SOLUTIONS INC., Los Angeles, CA (US)

(72) Inventor: John Carl, Hayward, CA (US)

(73) Assignee: THERMOSHADE SOLUTIONS INC., Los Angeles, CA (US)

(21) Appl. No.: 19/341,680

(22) Filed: Sep. 26, 2025

Related U.S. Application Data
(63) Continuation-in-part of application No. 18/821,986, filed on Aug. 30, 2024, now Pat. No. 12,428,847.
(60) Provisional application No. 63/535,690, filed on Aug. 31, 2023.

(51) Int. Cl. F24S 20/66; A45B 23/00; F24S 80/60

(52) U.S. Cl. CPC F24S 20/66; A45B 23/00; F24S 80/60; A45B 2023/0093

(57) ABSTRACT

Thermal energy management and cooling systems are provided. In various embodiments, passive systems are provided that do not require a flow of liquid or the provision of electrical energy to deliver the cooling effect. Panels and shade structures are disclosed that comprise various features including, for example, phase change materials that are operable to cool an area or volume beneath or proximal to the panel.

This U.S. Non-Provisional patent application is a Continuation-in-Part of and claims the benefit of priority from U.S. Non-Provisional patent application Ser. No. 18/821,986, filed on Aug. 30, 2024, which claims the benefit of priority from U.S. Provisional Patent Application No. 63/535,690, filed on Aug. 31, 2023, the entire disclosures of which are hereby incorporated by reference.

### FIELD

Embodiments of the present disclosure relate to methods and systems for structural elements useful for covering and shading various areas. Certain embodiments of the present disclosure contemplate the inclusion of one or more phase-change materials to provide enhanced cooling beneath or proximal to the structure. While various embodiments shown and described herein are well suited for providing shade and cooling, it will be recognized that embodiments of the present disclosure are not limited to providing shade. Systems of the present disclosure can provide various benefits including, for example, protection from various elements, ornamental and aesthetic benefits, and other features and benefits.

### BACKGROUND

The benefits of protective, overhead coverings and shelters are well known. In 2024, however, the human race is presented with a warming planet that will require various adaptations in order for humans to continue to thrive. It is currently estimated that approximately 500,000 people die each year from heat-related causes. It is also known that various health conditions result from or are exacerbated by extreme heat even if such conditions are not fatal. The conditions that contribute to these issues are not expected to abate. For example, the city of Los Angeles, California is expected to experience three times as many extreme heat days by mid-century as compared with today.

Many urban environments lack shading structures, whether they be natural or man-made. Urban corridors devoid of shade and comprising vast areas of concrete and asphalt are known to suffer greater consequences in high heat conditions. Accordingly, there exists a long-felt and unmet need to provide cooling and thermoregulation solutions that are relatively quick and easy to install, require little or no electrical power or energy use, and which provide affordable shading and cooling to various environments.

### SUMMARY

It is an object of the present disclosure to provide methods and systems for climate control, shading, covering, and/or protective structures that can be employed in various settings. Devices, systems and methods are contemplated for use in various settings and applications and no limitation with respect to the intended or final use of various embodiments of the present disclosure is provided herewith. For example, shading and cooling structures of the present disclosure are contemplated as being installed and used in public spaces, sidewalks, private outdoor spaces, parks, cafes, patios, outdoor parking facilities, multi-use paths, amusement parks, sports facilities, outdoor lines and queues, and various other applications. The foregoing are intended to serve as examples only and various other uses and applications are possible as will be recognized by one of ordinary skill in the art. Furthermore, systems and methods of the present disclosure are contemplated as being provided as permanent, semi-permanent, or temporary installations.

Certain embodiments of the present disclosure provide overhead or shade coverings that comprise one or more phase-change materials (hereafter “PCM”). As used herein, a PCM is a substance that either releases or absorbs energy at a phase transition to provide heating or cooling properties. No limitation with respect to a particular PCM or the states of matter provided with the PCM is provided. One example of a thermal management system and PCM contemplated for use with embodiments of the present disclosure is shown and described in U.S. Pat. No. 10,088,251 to Raman et al., which is hereby incorporated by reference in its entirety. A further example of known PCM materials is provided by U.S. Pat. No. 8,333,093 to Rolland et al. and U.S. Pat. No. 4,498,459 to Korin et al, which are hereby incorporated by reference in their entireties.

Embodiments of the present disclosure contemplate the provision of a multi-layered or composite structure. Structures and covers of the present disclosure contemplate a panel or surface that comprises a plurality of elements which may include, for example, a PCM, a reflective component, various structural components, ventilation, heat exchangers, airflow channels, a protective layer (e.g. a hail-protective layer), a water-proofing layer, photovoltaic components, and a transparent or translucent element.

Various embodiments of the present disclosure contemplate device mobility regardless of the particular make-up of the covering. For example, various embodiments of the present disclosure contemplate that a panel or covering is moveable (e.g. tiltable, rotatable, etc.) in order to maximize shade and/or photovoltaic efficiency (in embodiments that comprise photovoltaic features) as the sun moves throughout the day or based on user preference.

In one embodiment, a thermal management structure is provided that comprises at least one of a frame and a support member. A panel member is provided that comprises a plurality of components and wherein at least one of the plurality of components comprises a phase change material. The panel member extends over at least a portion of an area to be thermally managed and wherein the panel is operable to reflect energy before it reaches the area and cool the area by the absorption of heat energy in the phase change material. The thermal management structure may further comprise at least one rotatable element to increase efficiency based on a relative position of the sun. Thermal management structures of various embodiments contemplate that the phase change material is operable to provide cooling benefits by absorbing heat during a phase change during hot, daylight hours and recharge during nighttime hours by releasing latent heat.

It is a further object of the present disclosure to provide systems that are relatively inexpensive and simple to install and to scale. Accordingly, certain embodiments of the present disclosure comprise structures and systems for interconnecting a plurality of panels or coverings as shown and described herein and such that systems can be expanded or scaled.

It is contemplated that structures and panels of the present disclosure comprise various sizes, shapes and arrangements. No limitation is provided with respect to environments and/or applications that the embodiments of the present disclosure are applied to. For example, building envelopes, bus roof shelters, shipping containers, bench coverings, vehicle cockpits, electric vehicle charging stations, cabanas, ceiling structures (e.g. panels) and similar features may be provided with features and environments of the present disclosure. In various embodiments and as shown and described herein, features of the present disclosure are contemplated as being provided with interior or enclosed spaces and the disclosure is not limited to outdoor structures. For example, ceiling structures are contemplated as being provided with various features (PCM features and others) to cool an interior or enclosed space that is equipped with a heating, ventilation or air conditioning system. Such systems offer enhanced cooling, thermal management, and energy efficiencies at least as compared with conventional systems alone.

While various embodiments of the present disclosure rely at least partially on PCM features for enhanced cooling, additional cooling systems are contemplated as being provided. For example, powered fans, motors, pumps and similar features are contemplated as being provided.

In various embodiments, systems and coverings of the present disclosure also comprise additional energy capture features such as photovoltaics. The systems may also comprise integrated lighting systems, charging stations, etc. It is also contemplated that panels and structures of the present disclosure may comprise various connectivity or IoT features. For example, panels may be in communication with a system or network to track conditions of the system (e.g. daylight hours experienced, photovoltaic watts produced, etc.).

Panels of the present disclosure are contemplated as comprising various textures and colors to increase or decrease reflectivity, alter the ability to clean a panel, increase UV protectiveness, etc. Additionally, various embodiments of the present disclosure contemplate the incorporation of advertising, soundproofing materials, sound systems, etc.

Further embodiments according to the present disclosure are directed to panel assemblies that incorporate a thermal management assembly for recharging a phase change material without incorporating a fluid recharger. The inventive panel assemblies may be provided as standalone panels or as an array of panels that are part of a self-standing structure for thermal management. The panel assemblies only provide a shaded area for occupants and are also operable to maintain a constant surface temperature that is generally cooler than the temperature of the occupants of an area to be thermally managed. In various embodiments, a phase change material of the individual panels are operable to absorb heat from the occupants resulting in a temperature exchange that cools the occupants. Generally, the phase change material starts as a solid material at the beginning of a period of operation and becomes at least partially or completely liquid due to heat exchanges during periods of operation. At the end of a period of operation, a thermal management assembly of the panels may be selectively or automatically activated to remove heat stored within the phase change material thereby returning it to a solid state. During periods of non-operation, a thermoelectric device or cooler of the thermal management assembly is operable to absorb stored heat from the phase change material and to convey it to the exterior air.

In one or more embodiments, the inventive panel assembly comprises a phase change material (PCM) that is at least partially insulated or otherwise surrounded by one or more layers of an insulation assembly. In various embodiments, a panel assembly is provided comprising a first insulation layer that is structured to convey heat across the first insulation layer. In some embodiments, the first insulation layer and the second insulation layer are collectively configured and dimensioned to insulate at least a portion of the phase change material, and in some embodiments a majority or substantially all of the phase change material, including to minimize convection heat transfer.

In one or more embodiments, the first insulation layer comprises a containment layer and a film layer disposed in a spaced apart relation to one another and collectively defining an air gap, which serves to insulate the phase change material from the exterior. The containment layer is generally structured to at least partially support the weight of the phase change material above it, including to maintain the air gap. Generally, the film layer comprises a material structured to permit latent heat transfer between the area to be thermally managed and the phase change material. In one or more embodiments, the film layer comprises a transparent material structured to allow conveyance or passage of long wave infrared radiation (LWIR). The film layer generally defines an outer boundary of the first insulation layer that faces the exterior. As such, the film layer serves as a barrier that insulates the phase change material lowering convection heat transfer while allowing conveyance of long wage infrared radiation (LWIR).

In some embodiments, the insulation assembly further comprises a second insulation layer configured to at least partially surround the phase change material. In some embodiments, the second insulation layer comprises a material that is also structured to convey heat across the second insulation layer. In one or more embodiments, the second insulation layer comprises an opaque material.

As briefly mentioned above, the thermal management assembly is operatively structured with the phase change material to automatically or selectively re-charge it during periods of non-operation. A thermoelectric cooler(s) of the thermal management assembly is generally configured to draw latent heat from the phase change material that was absorbed during periods of operation or use. The thermoelectric cooler(s) is also generally configured to convey the latent heat from the phase change material to a roof assembly that is operable to dissipate or otherwise transfer the heat to the exterior. In one or more embodiments the thermoelectric cooler(s) comprises a heat conduction pad and is operatively structured with temperature sensors that can detect the temperature of the phase change material and/or within the thermal management assembly, including within the thermoelectric cooler(s).

In some embodiments, the thermoelectric coolers are operatively structured with an integrated controller configured to selectively or automatically begin operation of the thermoelectric coolers or devices. In one or more embodiments, the thermal management assembly optionally comprises an integrated power supply configured to supply power to the thermoelectric coolers or devices of each panel. In other embodiments, individual or groups of thermal management assemblies are configured to draw power from standard wall sockets.

In one or more embodiments, individual panel assemblies comprise a roof assembly operatively structured with the thermal management assembly to dissipate absorbed heat from the phase change material to the exterior. The roof assembly generally comprises a roof panel configured to reject heat into the sky. In one or mor embodiments the roof panel is provided with a material comprising high reflectance to solar irradiance.

While various embodiments of the present disclosure contemplate permanent or semi-permanent structures, it is further contemplated that systems of the present disclosure comprise smaller, lightweight versions that are portable or easily movable.

Various concepts disclosed herein may be provided in combination with one another even if such combination is not specifically depicted or described.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In addition, the materials, methods, and examples are illustrative only and are not intended to be necessarily limiting.

### DESCRIPTION OF THE DRAWINGS

Those of skill in the art will recognize that the following description is merely illustrative of the principles of the disclosure, which may be applied in various ways to provide many different alternative embodiments. This description is made for illustrating the general principles of the teachings of this disclosure and is not meant to limit the inventive concepts disclosed herein.

The accompanying drawings, which are incorporated in and constitute a part of the specification, illustrate embodiments of the disclosure and together with the general description of the disclosure given above and the detailed description of the drawings given below, serve to explain the principles of the disclosure.

FIG. 1 is a perspective view of a protective shading structure according to one embodiment of the present disclosure.

FIG. 2A is a perspective view of a protective shading structure according to one embodiment of the present disclosure.

FIG. 2B is a perspective view of the structure of the embodiment of FIG. 2A.

FIG. 3 is a perspective view of a protective shading structure according to one embodiment of the present disclosure.

FIG. 4 is a perspective view of a protective shading structure according to one embodiment of the present disclosure.

FIG. 5A is a perspective view of a protective shading structure according to one embodiment of the present disclosure.

FIG. 5B is a perspective view of the structure of the embodiment of FIG. 5A.

FIG. 6A is a perspective view of a protective shading structure according to one embodiment of the present disclosure.

FIG. 6B is a perspective view of the structure of the embodiment of FIG. 6A.

FIG. 7 is a perspective view of a protective shading structure according to one embodiment of the present disclosure.

FIG. 8 is a perspective view of an arrangement of protective shading structures according to one embodiment of the present disclosure.

FIG. 9A is a perspective view of an interconnection system for a structure according to an embodiment of the present disclosure.

FIG. 9B is a perspective view of the embodiment of FIG. 9A.

FIG. 10A is a perspective view of a protective shading structure according to an embodiment of the present disclosure.

FIG. 10B is a perspective view of the embodiment of FIG. 10A.

FIG. 10C is a perspective view of the embodiment of FIG. 10A.

FIG. 11 is an exploded perspective view of components of a system according to embodiments of the present disclosure.

FIG. 12 is an exploded perspective view of components of a system according to embodiments of the present disclosure.

FIG. 13 is a perspective view a component of a system according to an embodiment of the present disclosure.

FIG. 14 is an exploded perspective view of a passive cooling panel assembly according to another embodiment of the present disclosure.

FIG. 15 is a perspective view of a passive cooling panel assembly according to another embodiment of the present disclosure.

FIG. 16A is a perspective view of one embodiment of a shade structure according to the present disclosure.

FIG. 16B is a bottom perspective view of the embodiment depicted in FIG. 16A.

FIG. 17A is a perspective view of a self-standing thermal management structure according to one or more embodiments of the present disclosure.

FIG. 17B is a perspective view of another self-standing thermal management structure according to one or more embodiments of the present disclosure.

FIG. 18 is a perspective view of a panel assembly for thermal management according to one or more embodiments of the present disclosure.

FIG. 19 is a perspective cross-section view of a panel assembly for thermal management according to one or more embodiments of the present disclosure.

FIG. 20 is a side cross-section view of a panel assembly for thermal management according to one or more embodiments of the present disclosure.

FIG. 21 is a side cross-section view of further panel assembly for thermal management according to one or more embodiments of the present disclosure.

FIG. 22 is a side cross-section view of a portion of a panel assembly for thermal management according to one or more embodiments of the present disclosure.

FIG. 23 is a bottom view of a portion of a thermal management assembly according to one or more embodiments of the present disclosure.

FIG. 24 is a schematic representation of a circuit of a thermal management assembly according to one or more embodiments of the present disclosure.

FIG. 25 is a schematic representation of an array of panel assemblies according to one or more embodiments of the present disclosure.

The drawings are not necessarily to scale. In certain instances, details that are not necessary for an understanding of the disclosure or that render other details difficult to perceive may have been omitted. It should be understood, of course, that the disclosure is not necessarily limited to the particular embodiments illustrated herein.

### DETAILED DESCRIPTION

Reference to an element by the indefinite article “a” or “an” does not exclude the possibility that more than one element is present, unless the context clearly requires that there be one and only one element. The indefinite article “a” or “an” thus usually means “at least one.”

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the particular system under study, and can be readily appreciated by one of skill in the art.

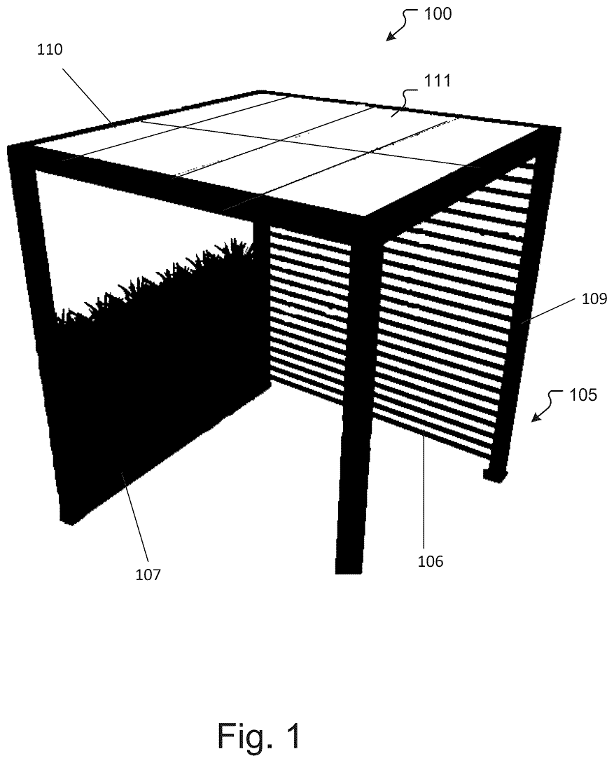

FIG. 1 is a perspective view of a covering and cooling system 100 according to an embodiment of the present disclosure. As shown, the system 100 comprises a lower frame 105 with vertical support elements 109 and an upper frame 110 that is operable to support various shading and cooling features 111. The system 100 provides an at least partially sheltered outdoor space of a particular square footage that may vary. The system 100 is contemplated as comprising additional features including, for example a trellis wall 106 and one or more planters or integrated horticultural elements 107.

The shading and cooling features 111 of the system of FIG. 1 are contemplated as comprising various elements including but not limited to a PCM. A combination of shade, solar reflectivity, and a PCM provides for a space beneath and proximal to the system 100 with significant cooling properties and benefits without the use of electrical power or water. Additionally, the system provides a low-maintenance, flexible, modular design that can be adapted to various spaces. The cooling features 111 are contemplated as comprising an ultra-reflective coating that is operable to reflect about 85% or more of the sun's solar energy and a PCM that stores and releases cool thermal energy during the hottest part of the day and is operable to “recharge” at night. The system is contemplated as comprising various features including, for example, a trellis wall 109 and/or a planter feature 107.

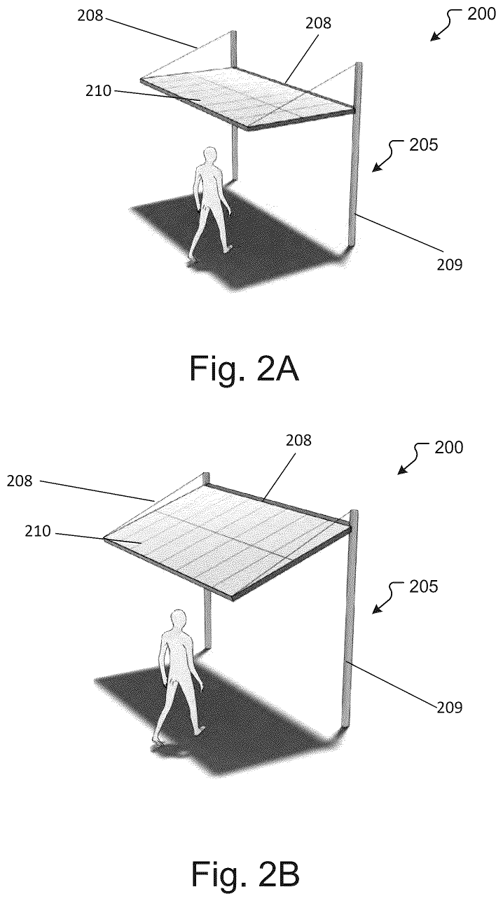

FIGS. 2A-2B are perspective views of a structure 200 according to an embodiment of the present disclosure. As shown, the system 200 comprises an adjustable shading and cooling panel 210 supported by vertical supports 209 and wherein the cooling panel 210 is provided within a frame 208 and the cooling panel 210 is rotatable or tiltable to accommodate, for example, angle of the sun relative to normal throughout the day. The cooling panel is contemplated as being supported by one or more wires or other support members and wherein at least a portion of the frame 208 is translatable relative to the vertical supports 209. In various embodiments, shading and cooling structures as shown and described herein are contemplated as comprising a controller and wherein the system is automatically adjustable based on an angle of the sun. The panel may be adjustable based on a time of day and/or detected angle of incidence of the sun's rays, for example. The cooling panel 210 of FIGS. 2A-2B are contemplated as comprising various cooling features, including but not limited to PCMs and related features.

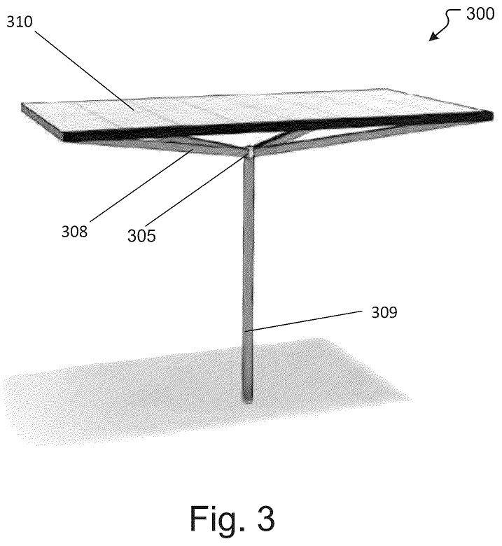

FIG. 3 is a perspective view of a structural element 300 according to an embodiment of the present disclosure comprising a vertical support member 309 and a plurality of struts 308 supporting a shading panel 310 of the present disclosure. The panel is contemplated as comprising one or more PCMs, a reflective member, layer or coating, and related elements as shown and described herein. The panel 310 is contemplated as being rotatable about a vertical and/or horizontal axis by the provision of a ball joint 305.

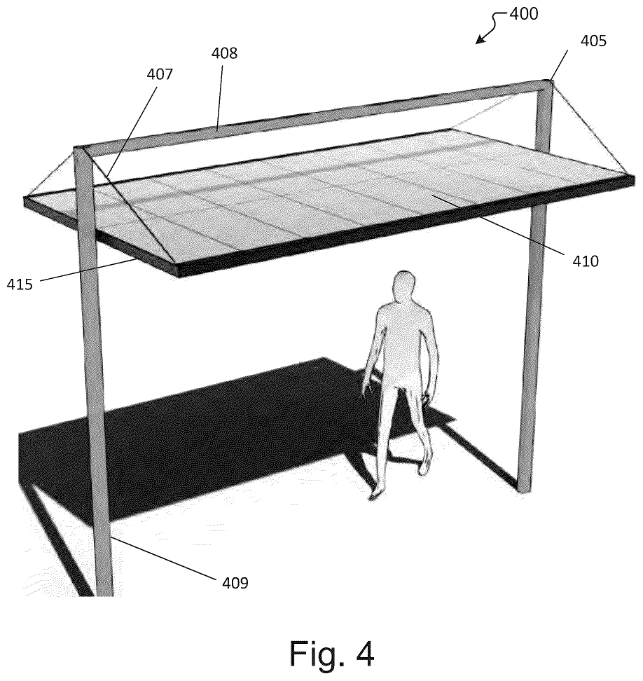

FIG. 4 is a perspective view of a shading and cooling structure 400 according to another embodiment of the present disclosure. As shown, the structure 400 comprises a cooling panel 410 supported by wires 407 extending from a frame 408 comprising vertical supports 409. The panel 410 is contemplated as being hung or suspended from the frame 408. In some embodiments, the panel 410 is simply suspended and allowed to sway when impacted by wind loads (for example). In the embodiment of FIG. 4, one or more actuators 405 are provided to translate a wire or cable 408 and alter the position at which the panel 410 is disposed.

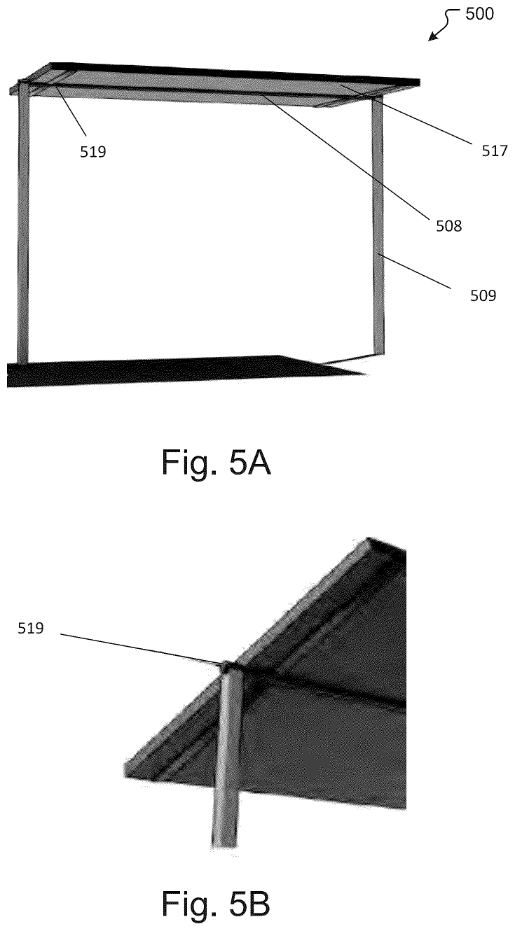

FIGS. 5A-5B are perspective views of a structure 500 according to an embodiment of the present disclosure. As shown, the structure 500 comprises a frame 509 having vertical supports and a rotatable axle 508 which supports a panel 517. The axle 508 and panel 517 are rotatable about a horizontal axis to adjust the angle of the panel relative to a ground surface, for example. The panel 517 is contemplated as being adjustable so as to increase and angle of incidence with the sun and/or cast a larger or more desirable shadow beneath the structure 500. An actuator 519 is contemplated as being provided to adjust the panel angle.

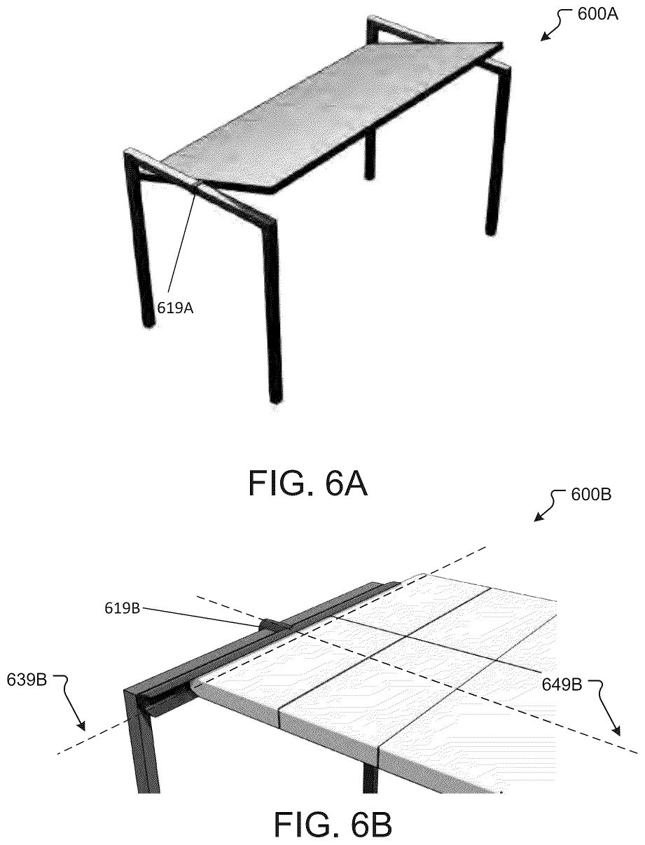

FIG. 6A is a perspective view of a structure 600A according to an embodiment of the present disclosure. As shown, the structure 600A comprises a frame with a tiltable panel that is rotatable about at least a horizontal axis extending through a pivot point 619A. FIG. 6B depicts a further embodiment of the present disclosure wherein the panel is rotatable about a central axis 649B that extends through a pivot point 619B. The panel of FIG. 6B is also translatable along a track such that is operable to move along a plane 639B as shown.

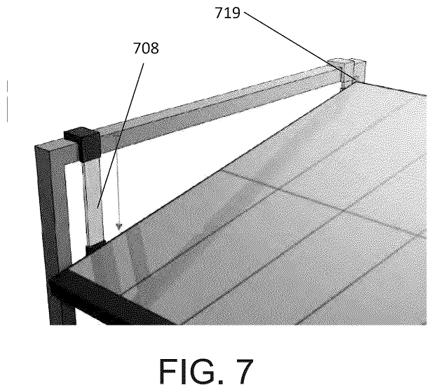

FIG. 7 is a perspective view of another embodiment of the present disclosure and wherein a panel is provided and secured to a frame. Connecting components such as hangars or braces 708, 719 are provided. As shown, the connecting components 708, 719 are contemplated as being of different size or length to allow the panel to be positioned at an angle.

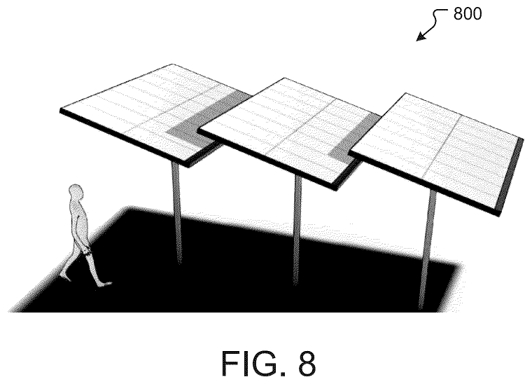

FIG. 8 is a perspective view of a system 800 of the present disclosure wherein a plurality of panels or coverings in accordance with the present disclosure are provided. As shown, a plurality of panel are provided to create a desired amount of surface area or volume beneath the system to be cooled. The panels are contemplated as comprising a PCM and may comprise any one or more of the embodiments of panels and coverings as shown and described herein. The panels may be adjustable and comprise features and structures as shown in FIG. 3, for example.

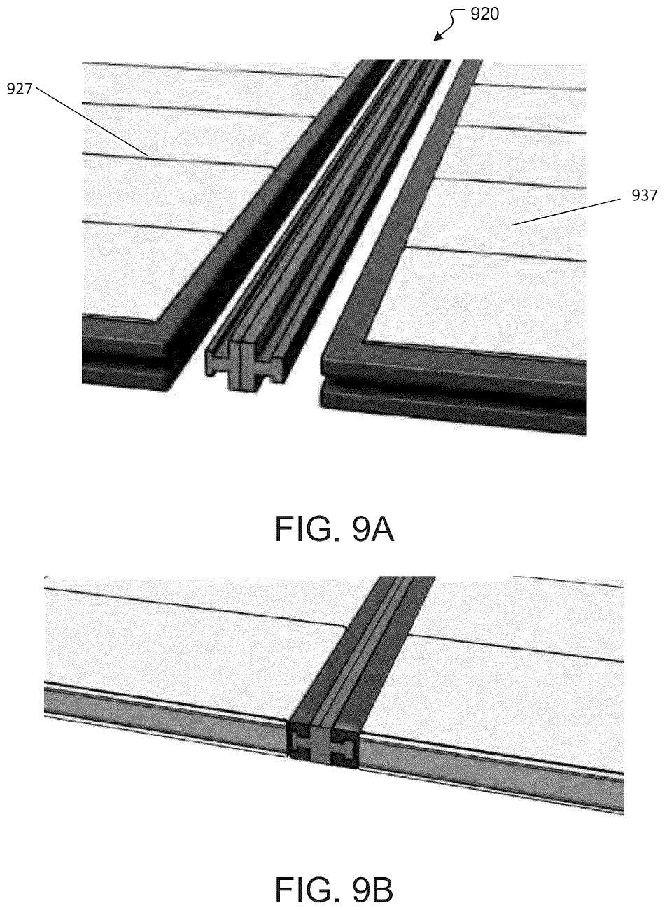

FIGS. 9A-9B are perspective views of a connecting and interconnecting system for panels 927, 937. As shown, a connecting rod 920 of a particular cross-sectional shape is provided and is operable to slidingly mate with first 927 and second 937 panels that comprise a slot or recess. In such a manner, the panels 927, 937 may be connected in an end-to-end manner and the system may be quickly and affordably scaled to cover various areas and environments. FIG. 9B illustrates an assembled pair of panels.

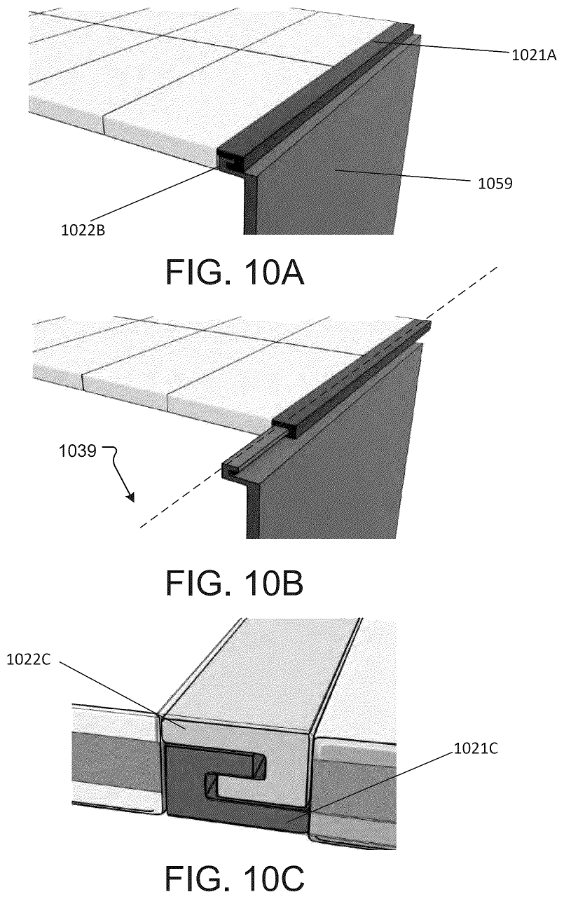

FIGS. 10A-10C depict a panel connection system according to another embodiment of the present disclosure. As shown in FIG. 10A, a lateral end of a panel comprises or is connected to a track member 1021A. A support member 1059 for supporting the panel is provided and comprises a corresponding track member 1022B. The track members 1021A, 1022B generally comprises opposed J-shaped members that are slidingly engageable with one other to secure the panel to the support member 1059. As shown in FIG. 10B, panel installation is enabled by sliding the track member 1021A along a plane 1039 and wherein the first track member 1021A engages the second track member 1022B. FIG. 10C depicts an embodiment of the present disclosure that is similar to the embodiment of FIG. 10A and wherein two adjacent panels are slidingly engaged by the track members 1022C, 1021C.

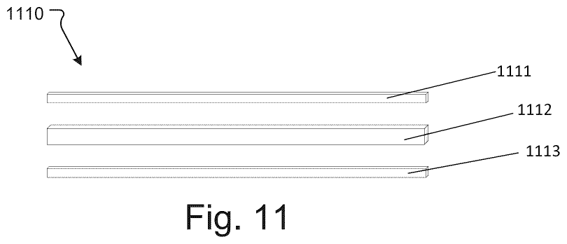

FIG. 11 is an exploded perspective view of a plurality of layers 1111, 1112, 1113 that are contemplated as forming a composite 1110 according to an embodiment of the present disclosure. As shown, the composite 1110 is contemplated for use with overhead shading, covering and cooling systems including those shown and described herein. The composite 1110 is contemplated as comprising a first upper layer 1111 which, in some embodiments, comprises a lid or cover member including solar reflective properties. A second, middle layer 1112 is provided which, in some embodiments, comprises one or more PCMs. A third, lower layer 1113 is provided that is contemplated as comprising a solid surface, mesh screen, or grate for supporting the PCM while allowing for heat transfer through the third layer 1113, for example. The layers are contemplated as being welded, adhered, fastened, or simply stacked together. The composite 1110 is contemplated as being provided with a track or frame member and may be provided in combination with the various structures and applications as shown and described herein. Various additional layers are contemplated including, for example, an insulating layer, a photovoltaic layer and other layers and features.

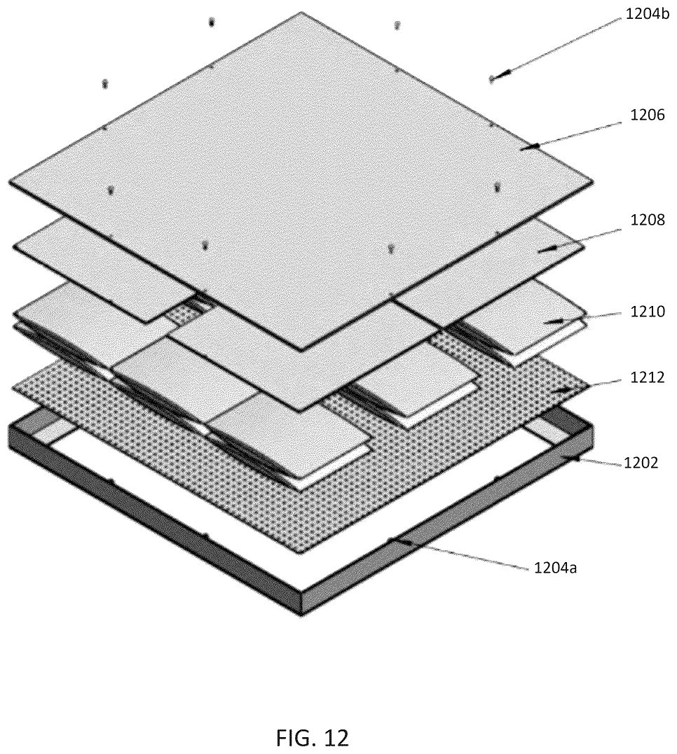

FIG. 12 is an exploded perspective view of a covering element 1200 according to an embodiment of the present disclosure. While the element 1200 of FIG. 12 is provided as a square shaded member of a certain size, no limitation with respect to dimensions, shape, or proportions are provided. As illustrated, the element 1200 comprises a bracket 1202 for receiving and supporting components. The components may be secured to or within the bracket 1202 by one or more fasteners 1204a, 1204b. More specifically, the element is contemplated as comprising a lid or covering 1206, an insulation layer 1208, one or more PCMs 1210, and a screen or perforated metal element 1212.

As shown, the lid 1206 preferably comprises a durable, lightweight outer housing with low thermal conductivity. In some embodiments, the lid 1206 comprises fiberglass to prevent or limit heat from transferring to the interior or underside of the panel. The lid 1206 is contemplated as comprising a reflective coating on the exterior of the lid. An insulation layer 1208 is provided that preferably comprises lightweight insulation with low thermal conductivity to prevent or limit solar energy from transferring through the panel and/or PCM. A PCM region or layer 1210 is provided. In some embodiments, the PCM region(s) or layer(s) provided within the structure comprises a salt-based PCM (e.g. hydrated inorganic salts, calcium chloride hexahydrate) and/or an oil-based PCM comprising emulsifiers, gelling agents, fatty acids, fatty alcohols, fatty esters, or their derivatives. By way of example and without limitation, one PCM that is contemplated as being provided in systems of the present disclosure is savENRG™ HS22 or HS24 that are commercially available from RGEES Ltd./PLUSS ADVANCED TECHNOLOGIES Pvt. Ltd. which are inorganic phase change materials. In other embodiments, it is contemplated that BioPCM™ 23Q M27 provided by Phase Change Solutions™ is provided in systems of the present disclosure. These specific PCMs are provided as examples only. Derivatives and alternatives to these materials are contemplated as being within the scope of the present disclosure and the PCM(s) provided may be varied and altered based on site-specific conditions, commercial availability, user requirements or desires, etc.

In various embodiments, systems of the present disclosure are optimized and designed for specific climate regions. For example, PCMs are contemplated as being selected based on average day and nighttime temperatures for a specific region. It is contemplated that for regions with average summer temperatures at 80° during the day and 60° at night, a PCM comprising a melting point of 22° C. is provided. As a non-limiting examples, for regions with hotter climates (e.g. 100° F. during the day and 80° F. at night), a PCM comprising a melting point of approximately 30° C., which may be higher or lower, is provided. In some embodiments, an oil-based PCM is provided that can be injected into a flexible canopy material. In other embodiments, sodium chloride-based PCMs are provided in rigid or semi-rigid structures.

A screen or mesh layer 1212 is provided in some embodiments to allow for heat transfer between the PCM and the environment beneath, below or proximal to the system. In some embodiments, the screen layer comprises perforated metal. It is further contemplated, however, that the screen or mesh layer comprises one or more of solid metal, wood, fiberglass, and/or other suitable materials. It is also contemplated that systems are provided that are devoid of a mesh layer 1212.

The covering element 1200 of FIG. 12 is contemplated as comprising a single unit and wherein a plurality of units may be assembled or provided to achieve the desired amount of surface area and coverage in various applications. Connection elements and structures as shown and described herein, for example, are contemplated as comprising any number of elements 1200 as shown in FIG. 12.

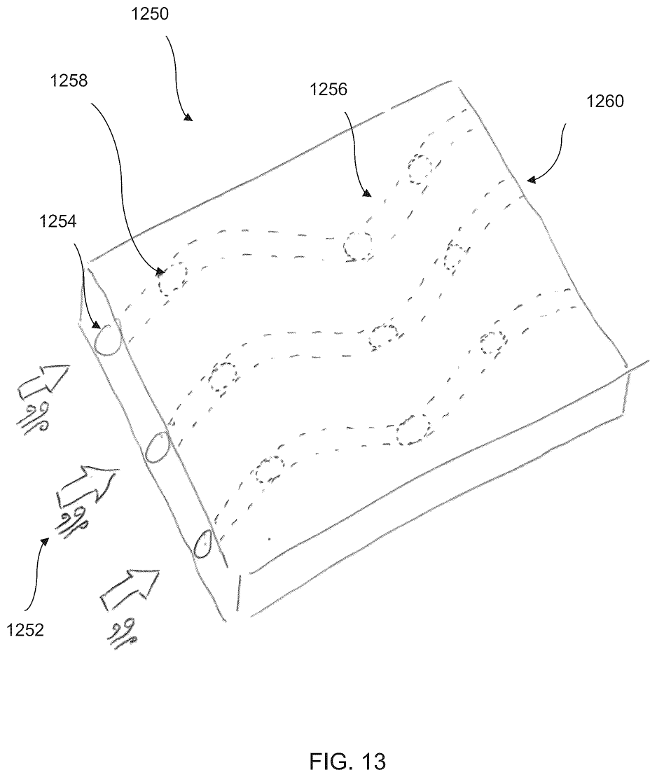

FIG. 13 is a perspective view of an element 1250 according to one embodiment of the present disclosure. The element 1250 of FIG. 13 comprises a flow element that is operable to direct, focus, or channel a working fluid or gas, including air, within the system. As shown, the element 1250 comprises ports 1254 along at least one lateral end of the element to direct flow 1252. Channels 1256 are provided within or through the element. The channels 1256 are contemplated as comprising serpentine or circuitous panels to increase surface area direct flow along a desired path. Egress ports 1258 are contemplated as being provided along the length of the channels to direct flow to areas beneath the panel(s). Second egress ports 1260 are contemplated as being provided at an opposing lateral end of the panel from the inlet ports 1254. The second egress ports are contemplated as being passive vents to allow flow to the outside environment. Alternatively, the second egress ports 1260 are contemplated as directing flow to inlet ports of a second, adjacent panel (not shown in FIG. 13). It is further contemplated that second egress ports 1260 are provided with seals or caps such as when the panel 1250 comprises the last panel in a series and/or when it is desirable to direct flow through the first egress ports 1258. It will be recognized that flow ingress and egress ports 1254, 1258 are contemplated as comprising substantially the same structure and may be referred to in the alternative.

The element 1250 of FIG. 13 is contemplated as being provided with various embodiments of the present disclosure and may be applied in various relative positions with respect to additional elements. For example, the element 1250 is contemplated as being provided directly above the PCM layer (in FIG. 12, for example) to direct flow across and/or onto the PCM. The element 1250 may be provided in various other locations, and more than one flow element 1250 is contemplated as being provided.

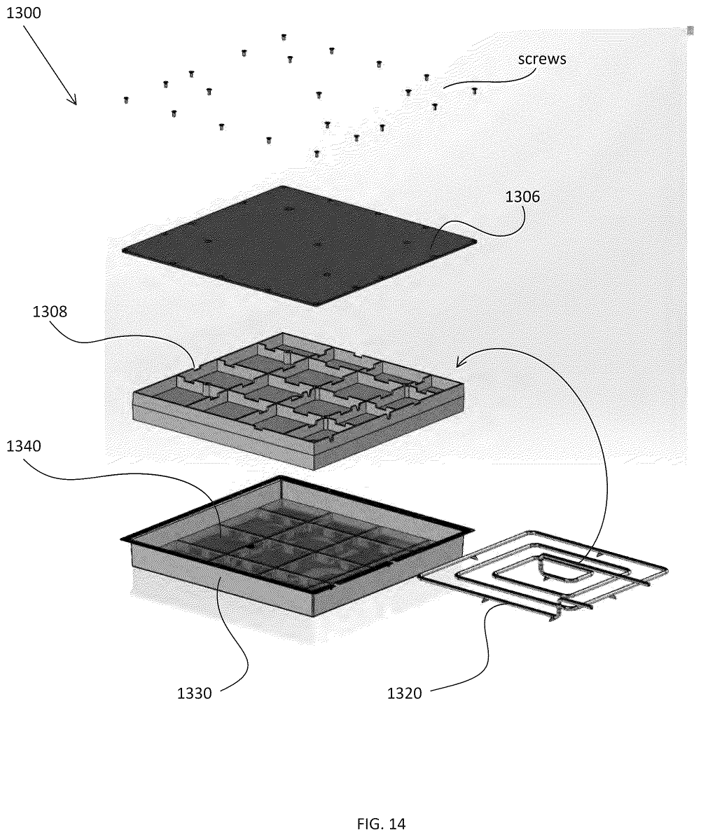

FIG. 14 is an exploded perspective view of a passive cooling panel assembly 1300 according to another embodiment of the present disclosure. The passive cooling panel assembly 1300 is generally intended for spaces where installation and user access is only feasible from a ceiling or interior side. Such an intended site may include without limitation, enclosed, partially enclosed, or open spaces in residential or commercial buildings. The passive cooling panel assembly 1300 incorporates an internal heat exchanger that can act a temperature management system to the space below. The passive cooling panel assembly 1300 may also comprise radiators configured to release latent heat. The internal heat exchanger 1320 is generally configured to remove latent heat by circulating a fluid at an intended temperature through a conduit system to induce a temperature exchange. As a non-limiting example, the thermal heat exchanger 1320 may comprise a piping system operatively configured with a pump to circulate water at an intended temperature. Ideally, this would be conducted during the evening to minimize disruption to occupied spaces.

Accordingly, and as shown in FIG. 14, the passive cooling panel assembly 1300 may comprise a support bracket 1330 configured and dimensioned to enclose a PCM layer 1340 and/or am insulating center layer 1308. The PCM layer 1340 is contemplated as comprising one or more PCM elements and, for example, may be substantially defined by an array of PCM panels or subsections operatively disposed within the support bracket 1330. A lid 1306 may be disposed above the support bracket 1330 and/or insulating center layer. The assembly 1300 may be secured in place by any one of a plurality of fasteners, i.e., screws, connectors, bolts, fastening mechanisms, etc. As such, the passive cooling panel assembly 1300 is generally an at least partially insulated and/or a fully insulated assembly around its perimeter. Such an arrangement as shown in FIG. 14 is advantageous as it can at least partially reduce parasitic heat absorption.

In various embodiments, cooling assemblies and systems are contemplated as comprising or permitting a flow of fluid. Heating and cooling efficiencies within a system or environment are contemplated as being improved in some embodiments by connecting fluid conduits (e.g. a heat exchanger 1320) to additional components. For example, a fluid (e.g.) water that has been heated by latent heat from a room and/or PCM may be connected to additional systems to provide heated water to a home plumbing system. The fluid and related conduit is also contemplated as being connected to a geothermal system (small or large scale) to convey thermal energy to a large heat sink, for example.

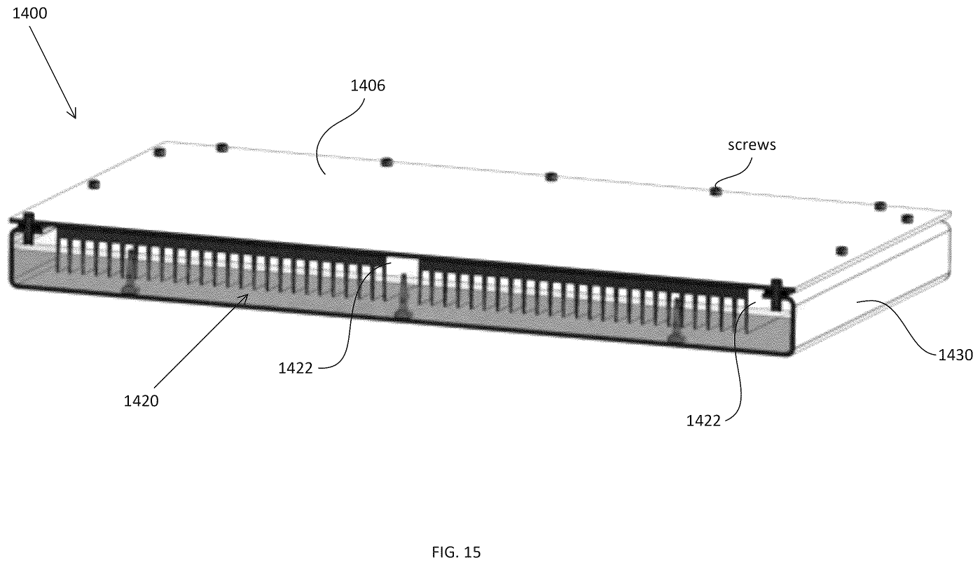

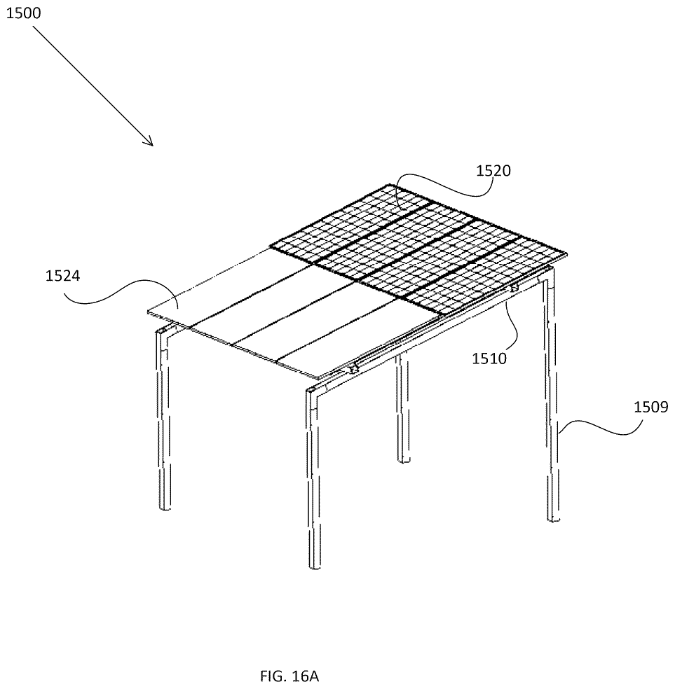

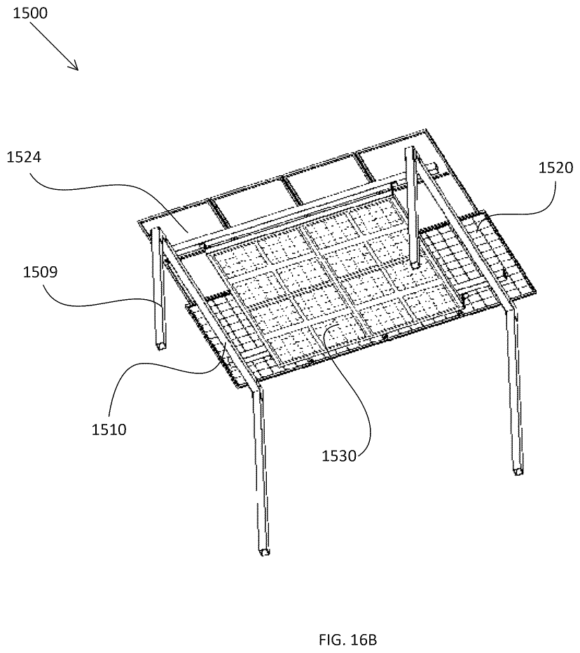

FIG. 15 is a perspective view of a passive cooling panel assembly 1400 according to another embodiment of the present disclosure. The passive cooling panel assembly 1400 is generally intended for spaces where both the ceiling and the roof are accessible for its installation, service, etc. The passive cooling panel assembly 1400 is generally configured to not only act as a passive temperature management assembly to the area below it, but also as an assembly that is capable of dissipating stored heat to the exterior, for example, at nighttime. Said differently, the passive cooling panel assembly 1400 should generate a cooling effect below it, i.e., on the ceiling, for example due to the cooling effect of PCM surfaces. However, the passing cooling panel assembly 144 should also act as a thermally conductive panel to the roof and/or to the exterior. As such, the present invention contemplates that the passive cooling panel assembly 1400 be used in combination with a specialized cool roof surface, e.g., a high-performance roof, that can radiate heat to the exterior.

As shown in FIG. 15, the passive cooling panel assembly 1400 generally comprises a bracket assembly 1430 that is operatively connected to a lid or roof panel 1406. By way of example, the assembly 1400, including the connection between the bracket 1430 and the lid 1406 may be secured in place by any one of a plurality of fasteners, i.e., screws, connectors, bolts, fastening mechanisms, etc. As is further shown in FIG. 15, a heat sink assembly 1420 comprising one or more individual heat sinks 1422 may be operatively disposed within the bracket assembly 1430. The heat sinks 1422 are generally bonded to the lid or roof panel 1406. As used herein, the term “heat sink” generally refers to temperature management element, i.e., a passive heat exchanger, that is capable of transferring or otherwise dissipating heat from another element or component. Thus, as herein contemplated, the heat sink assembly 1420 is generally configured to dissipate heat in an upward direction so that the roof may radiate the heat to the exterior. In addition to the heat sink assembly 1420, individual PCM structures, panels and/or layers may be disposed within the bracket assembly 1430, for example, below the heat sinks 1422. In an alternative embodiment, the heat sinks 1422 themselves may comprise a PCM material.

FIG. 16A is a perspective view of one embodiment of a shade structure 1500 according to the present invention. FIG. 16B is a bottom perspective view of the embodiment depicted in FIG. 16A. The shade structure 1500 can serve as a canopy or shade structure, which incorporates one or more of cooling panels 1530, including PCM panels, solar panels 1520 and/or radiative cooling panels 1524. As such, the shade structure can incorporate distinct elements, which may synergistically act to provide temperature-managed shaded area while also reducing its associated carbon footprint. For example, as shown in FIG. 16A vertical support elements 1509 may collectively support horizontal support elements 1510, which may be configured to support other support members and/or arrays of radiative cooling panels 1524 and solar panels 1520. As a further example, as shown in FIG. 16B, an array of PCM panels 1530 may be secured to support elements of the ceiling, i.e., below the roof and viewable when standing below the canopy. Such arrays of

PCM panels 1530 may be lifted and secured to the ceiling by using corner brackets and/or structural bolts. Additionally, a decorative trim may be added to cover the PCM array and/or the perimeter of the shade structure 1500.

Various embodiments of the present disclosure that comprise free-standing structures (e.g. the embodiment of FIGS. 16A-16B) are contemplated as being installed or deployed in various locations. In some embodiments, such free-standing structures are contemplated as comprising fluid flow channels for increasing efficiencies. In some embodiments, such fluid flow channels comprise air flow channels for allowing ambient air to flow through portions of the structure. It is also contemplated that free-standing structures comprise forced fluid flow features including pumped water heat exchangers and the like. The structures are contemplated as being connected to municipal water supplies, rain water supplies, and/or may be provided with a dedicated water (or other) source. Accordingly, it should be recognized that system comprising a liquid cooling element and related system are not limited to indoor systems or systems that are installed in a pre-existing building structure.

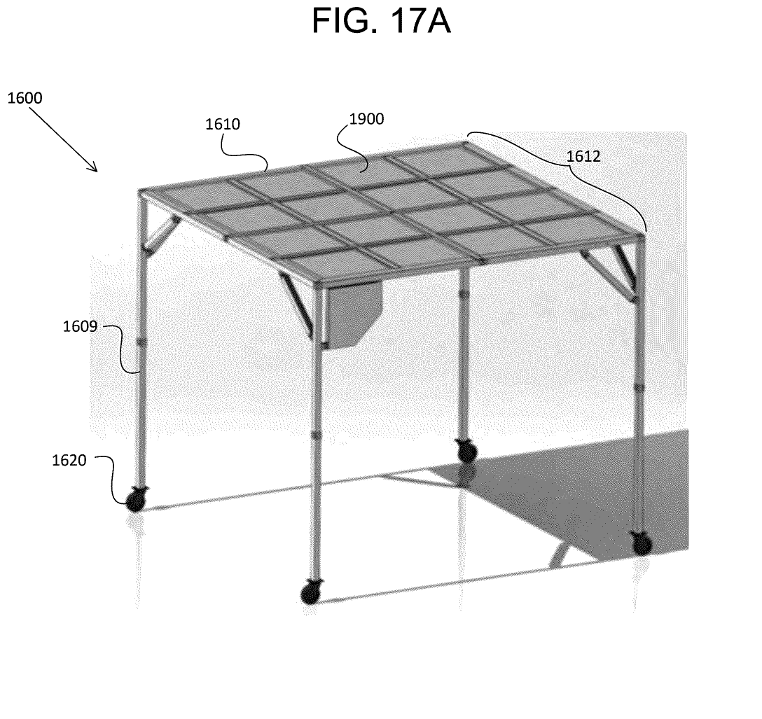

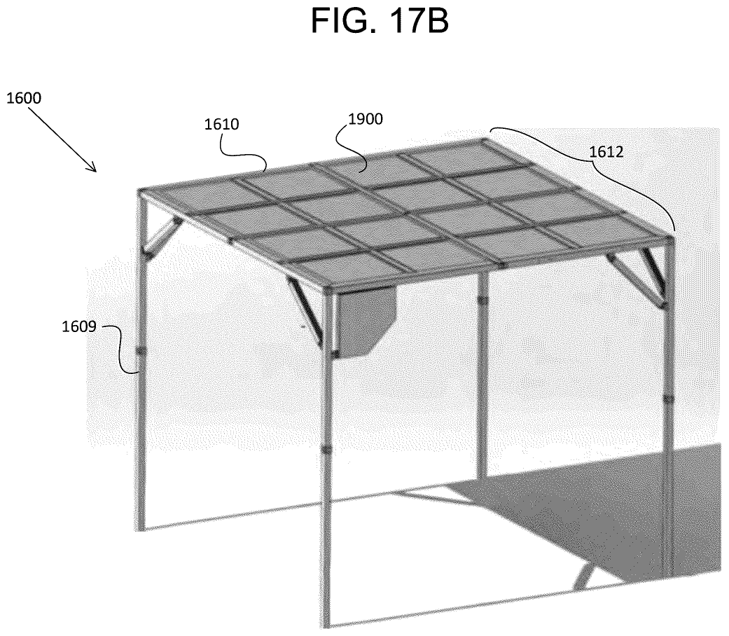

With reference now to FIGS. 17A-25, the present disclosure is further directed to additional embodiments of panel assemblies 1800 and/or 1900 that may be used for thermal management. As shown in FIGS. 17A-17B, in some embodiments the panel assemblies 1900 and/or 1800 define an array 1612 that is a part of a self-standing structure 1600 for thermal management. Individual panel assemblies 1900 and/or 1800 may be incorporated into existing structures and/or systems. As shown in FIG. 17A, in some embodiments a movable self-standing structure 1600 comprises a frame 1610 with a plurality of wheels 1620, with individual wheels 1620 being disposed below a corresponding vertical support element 1609. As a non-limiting example, in some embodiments each one of the plurality of wheels 1620 are locking caster wheels. As shown in FIG. 17B, in other embodiments, the self-standing structure 1600 comprises a frame 1610 that can be stationary or portable. As another non-limiting example, in one or more embodiments, a self-standing structure 1600 comprises a ceiling height that is approximately 8 feet and has a footprint of 10 feet by 10 feet. In one or more embodiments, an approximate weight of the self-standing structure is approximately 500 lbs. In some embodiments, a self-standing structure 1600 comprises sixteen panels 1800 and/or 1900, with each one being about 28-inch squares and weighing approximately 35 lbs. In one or more embodiments the sides of a self-standing structure 1600 are configurable to be open, partitioned and/or comprise a curtain-like arrangement. In at least one embodiment, the vertical support elements 1609 comprise an adjustable height. Systems of the present disclosure including but not limited to those shown in FIGS. 17A-17B are contemplated as comprising temporary, portable (or semi-portable shelters from the elements) and are contemplated for use in various settings. It is also contemplated that two or more structures 1600 can be assembled together and/or placed adjacent or proximal to one another to form a desired arrangement.

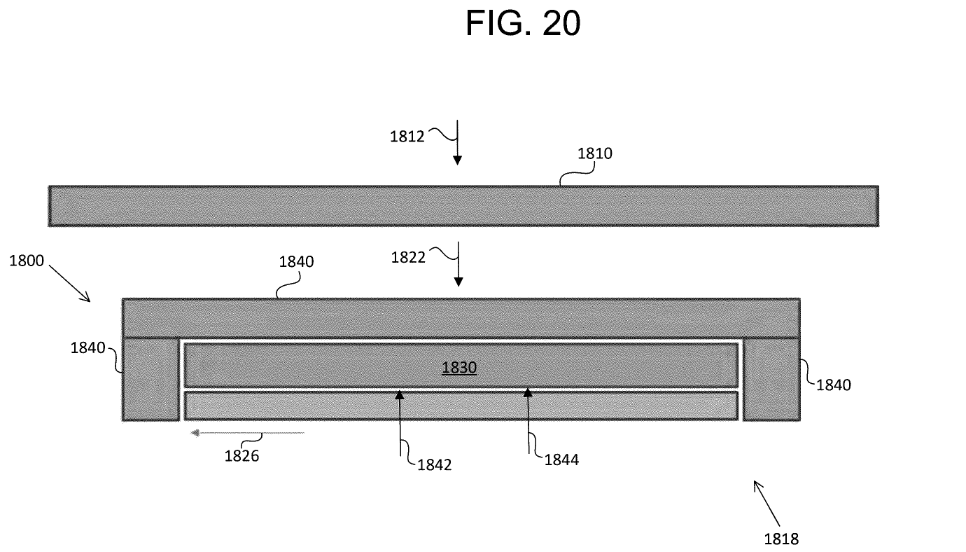

FIG. 20 is a cross-section side view of a panel assembly 1800 for thermal management according to one or more embodiments of the present disclosure. In the embodiment shown in FIG. 20, a panel assembly 1800 is provided below an existing structure 1810, which provides a cover or shade to the panel assembly 1800. The existing structure 1810 generally comprises a top face, which receives radiation 1812 from the sky. In one or more embodiments, at least some radiation 1822 is transmitted from the existing structure 1810 toward the top of the panel assembly 1800. In some embodiments, the existing structure 1810 is configured to reflect at least some of the solar radiation from above.

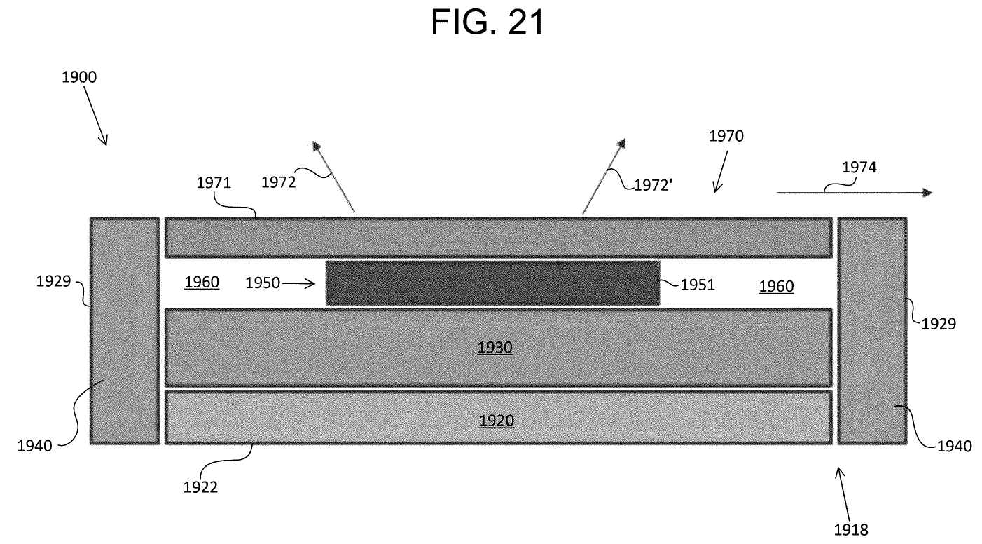

As shown in FIG. 20-21, in one or more embodiments, the panel assembly 1800 and/or 1900 comprises a phase change material (PCM), which is indicated at 1830 and/or 1930, and which is at least partially insulated or otherwise surrounded by an insulation assembly 1818 and/or 1918. As contemplated by various embodiments, the inventive panel assemblies 1800 and/or 1900 not only provide a shaded area for occupants, i.e., over an area to be thermally managed below an array 1612, but the panel assemblies 1800 and/or 1900 are also configured to maintain a constant surface temperature that is generally cooler than the temperature of the occupant(s) of the area to be thermally managed. As a result, this generally causes individual panels 1800 and/or 1900 to absorb heat from the occupant(s) resulting in a temperature exchange that cools the occupant(s). Generally, at least some of the heat from the occupants and/or the environment around the area to be thermally managed is absorbed by and/or stored within the phase change material 1830 and/or 1930. As such, the phase change material 1830 and/or 1930 is configured to absorb latent heat while maintaining a substantially constant temperature in the area to be thermally managed. In one or more embodiments, the panel assemblies 1800 and/or 1900 of a structure are operable to substantially lower the Mean Radiant Temperature (MRT) of the self-standing structure or shelter 1600, which reduces the Wet Bulb Globe Temperature (WBGT).

As contemplated by one or more embodiments according to the present disclosure, the individual panels 1800 and/or 1900 are intended to maintain the phase change material 1830 and/or 1930 in a latent heat state during their operation. Generally, the phase change material 1830 and/or 1930, which comprises relatively high latent heat with respect to sensible heat, starts as a solid material at the beginning of a period of operation, e.g., in the morning, and throughout the course of the period of operation, e.g., during the course of a day, the phase change material 1830 and/or 1930 becomes partially liquid, i.e., in a slurry state, or completely liquid, due to the temperature and/or heat exchanges with the occupants and/or area to be thermally managed. Once the phase change material 1830 and/or 1930 becomes fully, or at least partially liquid, e.g., toward the end of the day, a thermal management assembly 1950, which will be explained below, may be selectively or automatically activated, e.g., during periods of non-operation, to remove stored heat from the phase change material thereby re-solidifying the phase change material 1830 and/or 1930. Said differently, the thermal management assembly 1950 recharges the phase change material 1830 and/or 1930 during periods of non-operation by pumping heat out of the phase change material 1830 and/or 1930 and returning it to a solid state.

During periods of non-operation, a thermoelectric device or cooler 1951 of the thermal management assembly 1950, which is also known as a solid-state cooler or solid-state cooling device, absorbs stored heat from the phase change material 1930 and conveys it to the exterior air through a convection mechanism. As an example, the phase change material 1830 and/or 1930 may be an HS22 PCM manufactured by Akuratemp, LLC, including under the trademark AKURATEMP®. As contemplated by various embodiments according to the present invention, as electrons flow through the thermoelectric device or thermoelectric cooler 1951 the electrons carry heat from one side to the other. When the thermoelectric cooler 1951 is inactive, i.e., during periods of non-operation, it operates as an insulator to a portion of the phase change material 1930, given that it comprises a semi-conductor(s) around a middle section that comprises a thermal resistance, e.g., an R-value, that is substantially similar to that of glass. For example, the thermoelectric cooler 1951 may be an ETH-071-14-15-S-H1 manufactured by European Thermodynamics.

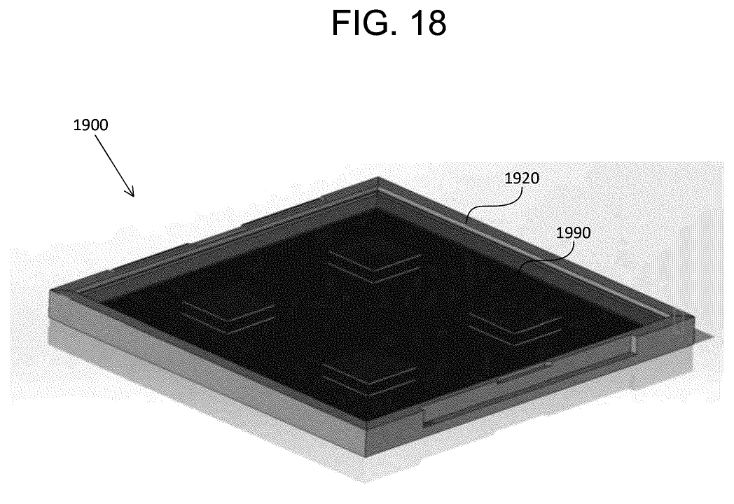

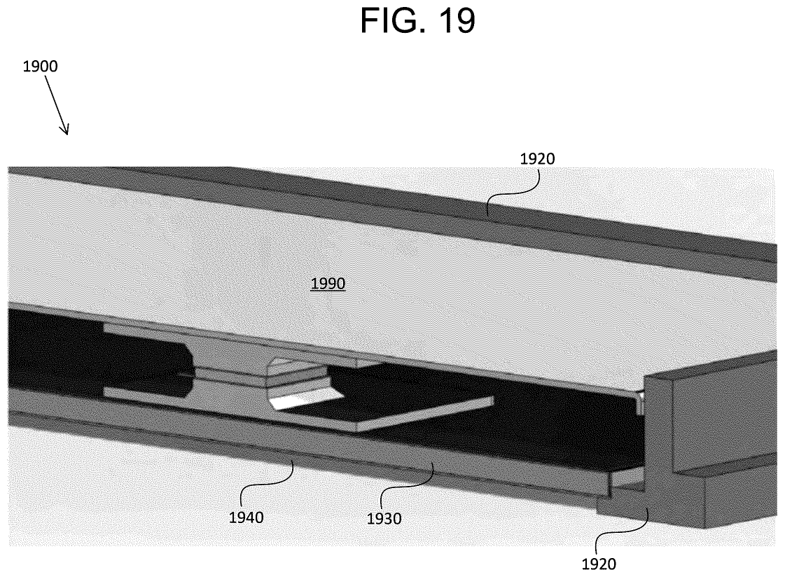

With reference now to FIGS. 18 and 19, one or more embodiments according to the present disclosure contemplate providing a panel assembly 1900 with a top panel 1990 that encloses the assembly 1900. In one or more embodiments, the top panel 1990 comprises an alloy, including without limitation, an aluminum sheet with a thickness about 0.08 inches. In at least one embodiment, the panel assembly 1900 comprises an aluminum machined block that is bonded and that is thermally coupled to the top panel 1990 and to the hot side of the thermoelectric device 1951. However, the foregoing is not necessarily limiting as the top panel 1900 and/or the block of the panel assembly 1900 comprises different types of alloys. In one or more embodiments, the block connects the cool side of the thermoelectric cooler 1951 to a containment layer 2070, which will be explained below.

As shown in FIGS. 20 and 21, in one or more embodiments, a panel assembly 1800 and/or 1900 is provided comprising a first insulation layer 1820 and/or 1920. As shown in FIG. 20, in at least one embodiment the first insulation layer 1820 is configured and dimensioned to surround or insulate substantially all of the phase change material 1830. As such, various embodiments according to the present disclosure contemplate at least partially insulating the phase change material 1830 and/or 1930 to minimize convection heat transfer, for example as shown at 1826.

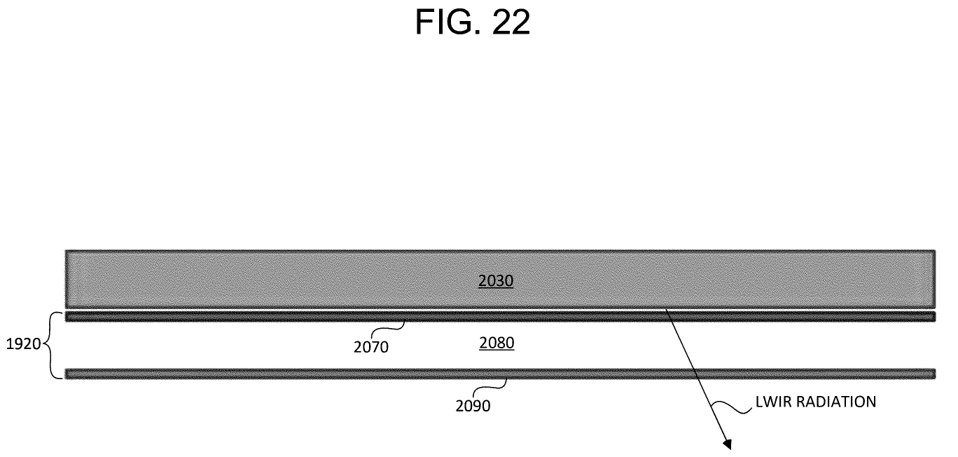

As shown in FIG. 22, the first insulation layer 1920 generally comprises a containment layer 2070 and a film layer 2090 disposed in a spaced apart relation to one another and collectively defining a gap 2080. In one or more embodiments, the gap 2080 is an air gap. However, this is not necessarily limiting as the gap 2080 may comprise a gas such as nitrogen or argon. Generally, the gap 2080 at least partially insulates the phase change material 1830 and/or 1930. In one or more embodiments, the gap 2080 is a narrow gap with a perimeter to area ratio of 0.2 or less. In at least one embodiment the gap 2080 comprises a width of about ⅜ inch. A narrow gap 2080 is beneficial in reducing the likelihood of convection currents being formed in the air within the gap 2080. In at least one embodiment, the gap 2080 comprises a pressure that is substantially equivalent to the exterior pressure, including to reduce the likelihood of pressure loading, which could damage the film layer 2090, for example, as a result of pressure differentials between the gap 2080 and the exterior. In one or more embodiments, the total thermal resistance of the gap 2080 and the film layer 2090 is at least 1.25.

The containment layer 2070 is generally structured to at least partially support the weight of the phase change material 2030 above it, including to maintain and/or enable the air gap 2080. In one or more embodiments, the containment layer 2070 is about 0.02 inches and comprises stainless steel. In at least one embodiment, the containment layer 2070 is bonded or welded to at least partially seal the phase change material 1830 and/or 1930. In some embodiments, a heat spreader is disposed above the containment layer 2070. In at least one embodiment, the heat spreader comprises a thickness of about 0.04 inches of aluminum. In some embodiments, the block (that connects the cool side of the thermoelectric cooler 1951 to the containment layer 2070), the heat spreader, and/or the containment layer 2070 are bonded and/or are thermally coupled.

Generally, the film layer 2090 comprises a material structured to permit conveyance of heat, including latent heat, from an area to be thermally managed toward the phase change material 1830 and/or 1930. In one or more embodiments, the film layer 2090 comprises a material structured to allow conveyance or passage of long wave infrared radiation (LWIR). For example, during periods of operation, heat transfer generally occurs between the area to be thermally managed, i.e., an area below an array 1612 of panels, and the phase change material 1830 and/or 1930. By way of example, in one or more embodiments, the film layer 2090 comprises a transparent material configured to permit the conveyance of latent heat from the area to be thermally managed toward the phase change material 1830 and/or 1930, for example, in directions 1842 and/or 1844.

As mentioned above, in at least one embodiment, the film layer 2090 is structured to at least partially permit conveyance of infrared radiation, including long wave infrared radiation, from the phase change material 1830 and/or 1930 to the exterior, for example, during periods of non-operation of the self-standing thermal management structure 1600. By way of example, in one or more embodiments, the film layer 2090 comprises a material with a high transparency in the spectral band of about 8 to about 14 micrometers (μm). By way of example, in at least one embodiment the film layer 2090 comprises a material that has a long wave infrared radiation (LWIR) transmissivity of about 65% and/or comprises a thickness of about 0.005 inches to about 0.010 inches. The film layer 2090 generally defines an outer boundary of the first insulation layer 1920 that faces the exterior. As such, the film layer 2090 is configured to serve as a barrier that partially insulates the phase change material 1830 and/or 1930 to at least partially lower and/or minimize convection heat transfer but that also allows conveyance or exchange of long wage infrared radiation (LWIR).

In various embodiments, the film layer 2090 comprises a material that is resistant to environmental exposure, including without limitation, a material that is UV resistant for incidental exposure and/or that is water resistant. In one or more embodiments, the material of the film layer 2090 is at least partially resistant to punctures and/or crack propagation. In at least one embodiment, the material of the film layer 2090 comprises a high yield and/or an ultimate tensile strength. In some embodiments, the material of the film layer 2090 is heat formable and/or comprises a surface energy that enables adhesive bonding, including to facilitate its fabrication. By way of example only, in at least one embodiment the material of the film layer 2090 is synthetic plastic sheet comprising about 0.010 inches and/or manufactured by Fresnel Technologies, Inc., under the brand name Poly IR® and/or Poly IR®2.

As shown in FIGS. 20-21, in some embodiments the insulation assembly 1818 further comprises a second insulation layer 1840 and/or 1940 configured to at least partially surround the phase change material 1830 and/or 1930. As shown in FIGS. 20 and 21, in one or more embodiments, the second insulation layer 1840 and/or 1940 at least partially surrounds or at least partially insulates the phase change material 1830.

In one or more embodiments, the second insulation layer 1840 comprises a material structured to convey heat across the second insulation layer 1840. For example, in one or more embodiments, the second insulation layer 1840 comprises an opaque material configured to convey heat across the second insulation layer 1840. In some embodiments the second insulation layer 1840 comprises a rigid insulation material, including without limitation, an expanded polystyrene (EPS) foam with a metallic protective film. An example of an opaque material of the second insulation layer 1840 is an R-tech rigid foam insulation, commercially available under the trademark Insulfoam® and manufactured by Carlisle EPS Holding, LLC.

In some embodiments, the perimeter 1929 comprises high-density polyethylene (HDPE), including milled HDPE.

With reference to FIGS. 21, and 23-24 various embodiments of the present disclosure further contemplates providing a panel assembly or assemblies 1900 comprising a thermal management assembly 1950 adjacently disposed to the phase change material 1930. In one or more embodiments, the thermal management assembly 1950 comprises a thermoelectric cooler 1951 operatively structured with the phase change material 1930 to selectively re-charge the phase change material 1930, including during periods of non-operation. As contemplated by one or more embodiments according to the present disclosure, a thermoelectric cooler(s) 1951 is generally configured to draw heat from the phase change material 1930 and convey it to a roof assembly 1970. In one or more embodiments, a thermoelectric cooler(s) is adjacently disposed to the phase change material 1930 and is configured to draw latent heat from the phase change material 1930 that was absorbed during periods of operation or use of a self-standing structure 1600 for thermal management as described herein.

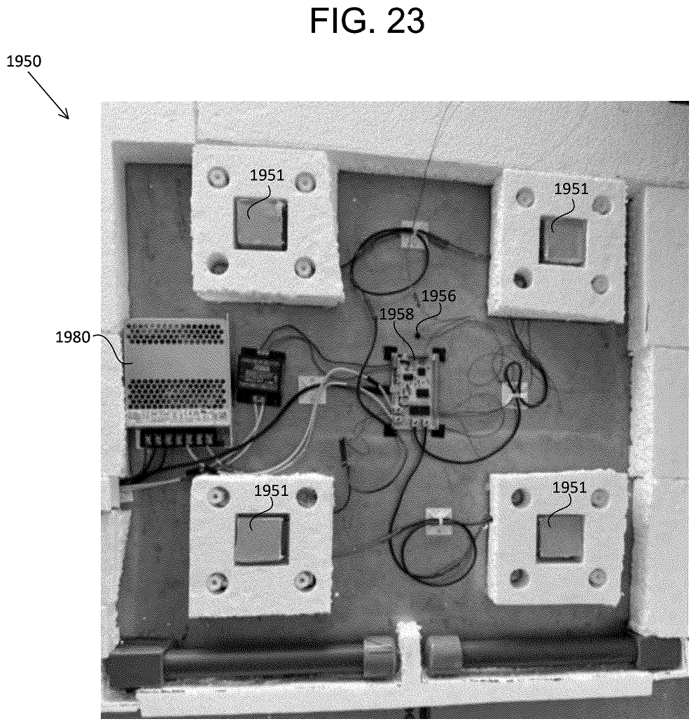

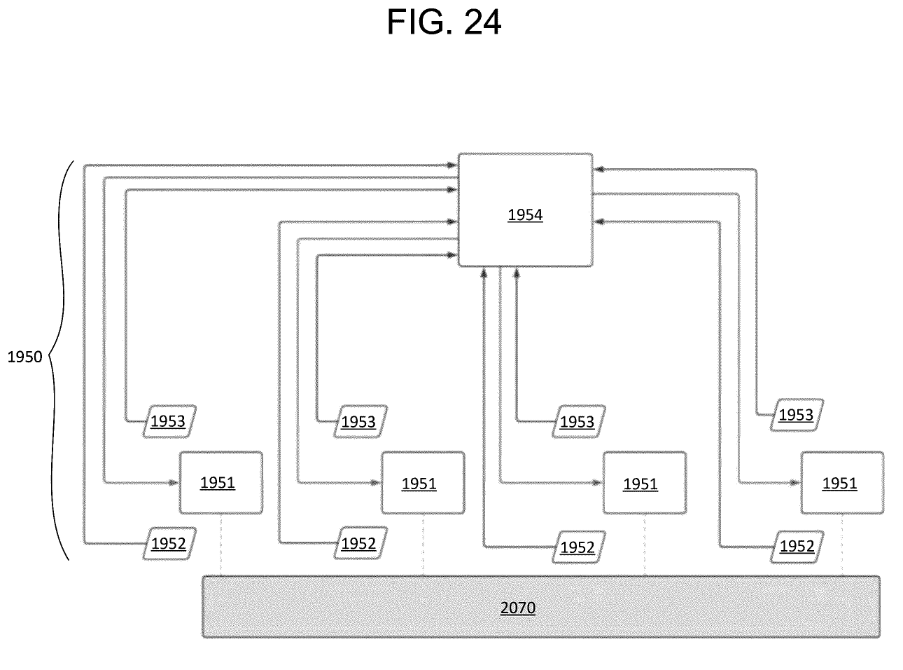

With reference to FIG. 23, in one or more embodiments the thermal management assembly 1950 comprises one or more thermoelectric coolers or devices 1951 that correspond to an individual panel assembly 1800 and/or 1900. In one or more embodiments, the thermoelectric coolers 1951 comprise a heat conduction pad (not shown) and are operatively structured with a temperature sensor 1956 that can detect the temperature of the phase change material 1930. In one or more embodiments, the heat conduction pad comprises one or more thermally conductive interface materials (TIMs). As contemplated by various embodiments of the panel assembly 1800 and/or 1900, thermally conductive interface materials (TIMs) are generally applied to at least some, and in some embodiments all, interfaces between parts to optimize heat transfer. As contemplated, the selection of thermally conductive interface materials (TIMs) can depend on specific design requirements. For example, in one or more embodiments a heat conduction pad(s) is disposed at the interface between the panel assembly 1800 and/or 1900 and the roof panel 1971, including to accommodate variable gaps. In at least one embodiment, the heat conduction pad comprises a boron nitride paste.

In one or more embodiments, a square pad that has sides that are approximately 4 inches surrounds a thermoelectric device 1951 with a square shape that has sides that are approximately 1.18 inches and that has a thickness of about 0.125 inches. For example, as is shown in FIG. 23, in some embodiments the thermal management assembly 1950 comprises four pads surrounding corresponding thermoelectric coolers 1951 and being disposed on the interior of a panel assembly 1900. In at least one embodiment, the space 2060 inside the panel 1900 is filled with insulation. In some embodiments, the space 2060 inside the panel 1900 is filled with an insulation material comprising cell foam, expanded polystyrene, or expanding insulating foam. In other embodiments, the space 2060 inside the panel 1900 is a void air space.

In some embodiments, the thermoelectric coolers 1951 are operatively structured with an integrated controller 1958 configured to selectively or automatically begin operation of the thermoelectric coolers or devices 1951. Such activation may be automatic, for example, based on a schedule, or based on the occurrence of a predetermined condition, including when the temperature of the phase change material 1930 and/or the thermoelectric device 1951 reaches or exceeds a predetermined threshold. In one or more embodiments, the thermal management assembly 1950 optionally comprises an integrated power supply 1980 configured to supply power to the thermoelectric coolers or devices 1951 of each panel 1900. In other embodiments, individual or groups of thermal management assemblies 1950 are configured to draw power from standard wall sockets, e.g., domestic or international power, 100-250 VAC, single phase, 50-60 Hz or similar. In at least one embodiment, individual or groups of thermal management assemblies 1950 are configured to use uninterrupted power supply (UPS) to operate independently. In at least one embodiment, a power distribution unit is configured to take external AC power and distribute it to the post motors and/or panel assemblies 1900. In other embodiments, a self-standing structure 1600 comprises battery powered components, e.g., battery powered fans and/or lights, which can be attachable to the vertical support elements 1609.

FIG. 24 is a schematic representation of a circuit of a thermal management assembly 1050 according to one or more embodiments of the present disclosure. As shown in FIG. 24, in one or more embodiments, circuitry of a thermal management assembly 1950 comprises individual groups that include a thermoelectric cooler temperature sensor 1953 and a phase change material temperature sensor 1952 operatively structured with a controller 1958. As is also shown in FIG. 24, in one or more embodiments, the controller 1958 is operatively configured with individual thermoelectric coolers 1951 to selectively or automatically adjust their operation as described herein. As contemplated by one or more embodiments according to the present disclosure, the temperature sensors 1952 are operable to monitor the cold side temperature of the phase change material 1930 to determine its state, and thereafter the controller 1958 drives the thermoelectric devices 1951 to pump heat out of the phase change material 1930 depending on various input conditions. As contemplated by at least some embodiments, the thermoelectric devices 1951 attempt to consume minimal power when the phase change material 1930 is passively cooling.

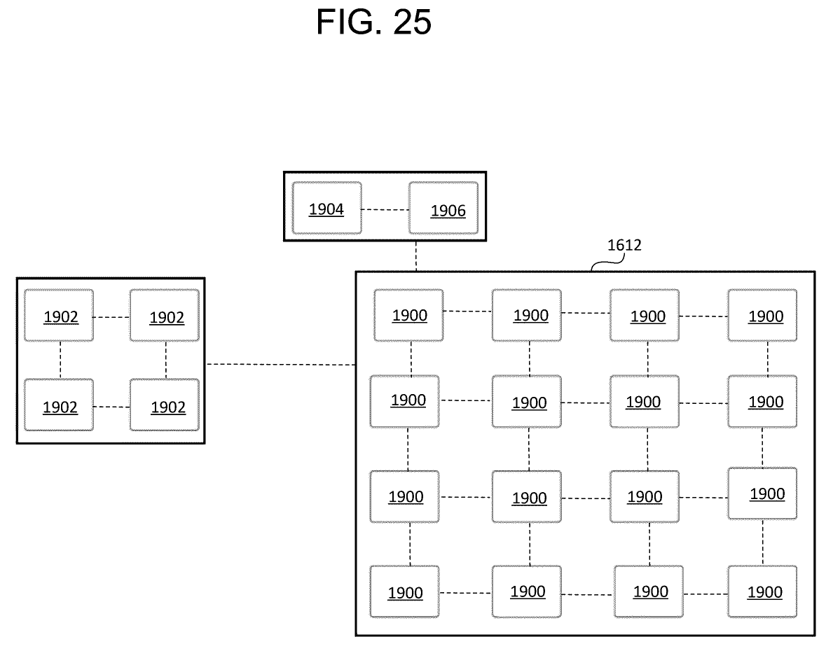

As shown in FIG. 25, in one or more embodiments, individual panels or panel assemblies 1900 of an array 1612 are communicably connected to one another and are operatively structured with one or more motors 1902 associated with one or more panel assemblies 1900 of a group or an array 1612. In some embodiments, the motors 1902 are communicably connected to one another. In at least one embodiment, individual ones or groups of the panel assemblies 1900 and/or motors 1902 are operatively structured with a single board computer (SBC) 1904 and/or a power distribution unit (PDU) 1906 respectively to adjust their operation and/or regulate or deliver power to the panel assemblies 1900 and/or motors 1902. For example, in some embodiments a single board computer 1904 is configured to log data from microcontrollers 1958 and/or communicate environmental climate conditions to the microcontrollers 1958. In some embodiments, the motors 1902 are configured to adjust the height of the vertical support members 1609 such that an array 1612 of panels is disposed at an intended height and/or a correct angle of inclination, for example, depending on the position of the sun relative to the self-supporting structure 1610. In one or more embodiments, the motors 1902 comprise stepper motors with integrated control electronics.

As is also shown in FIG. 21, individual panels 1900 comprise a roof assembly 1970 disposed adjacent to the thermal management assembly 1950. Generally, the roof assembly 1970 comprises a roof panel 1971 configured to reject heat into the sky, i.e., via a radiation exchange. Said differently, in one or more embodiments the roof panel of the roof assembly 1970 comprises a material configured to provide a high reflectance to solar irradiance. For example, in one or more embodiments, the roof panel 1971 of the roof assembly 1970 comprises a cool roof paint with a solar reflective index (SRI) value that is about 75 to about 125.

While various embodiments of the present disclosure are contemplated as providing shading and cooling features to mitigate the impacts of excessive heat, it should be recognized that the present disclosure comprises inventive aspects that are not limited to cooling or reducing temperature for comfort. Modifications to the panels and system disclosed herein are contemplated that allow a panel and PCM to emit thermal energy to warm a space.

The examples set forth above are provided to give those of ordinary skill in the art a complete disclosure and description of how to make and use the embodiments of the disclosure and are not intended to limit the scope of what the inventors regard as the scope of the disclosure. Modifications of the above-described modes for carrying out the disclosure can be used by persons of skill in the art and are intended to be within the scope of the following claims.

It is to be understood that the disclosure is not limited to particular methods or systems, which can, of course, vary. It is also to be understood that the terminology used herein is for the purpose of describing particular embodiments only and is not intended to be limiting.

A number of embodiments of the disclosure have been described. Nevertheless, it will be understood that various modifications may be made without departing from the spirit and scope of the present disclosure. Accordingly, other embodiments are within the scope of the following claims.

What is claimed is:

1. A panel assembly configured to at least partially extend over an area to be thermally managed, the panel member comprising:
a phase change material being operatively structured with an insulation assembly; the phase change material being operable to absorb conveyed heat thereby at least partially lowering the temperature of the area to be thermally managed;
the insulation assembly comprising a first insulation layer configured and dimensioned to at least partially surround the phase change material; and
wherein the first insulation layer comprises a material configured to allow conveyance of heat from the area to be thermally managed toward the phase change material.

2. The panel assembly of claim 1, wherein the material of the first insulation layer is configured to convey heat across the first insulation layer.

3. The panel assembly of claim 1, wherein the first insulation layer comprises a containment layer and a film layer disposed in spaced apart relation to one another and collectively defining a gap between them.

4. The panel assembly of claim 3, wherein the film layer comprises a transparent material structured to permit conveyance of heat from the area to be thermally managed toward the phase change material.

5. The panel assembly of claim 3, wherein the containment layer is adjacently disposed to and structured to retain the phase change material; and wherein the film layer defines an outer boundary of the first insulation layer that faces the exterior.

6. The panel assembly of claim 3, wherein the film layer is structured to at least partially permit conveyance of infrared radiation between the phase change material and the exterior.

7. The panel assembly of claim 1, wherein the insulation assembly further comprises a second insulation layer configured to at least partially surround the phase change material.

8. The panel assembly of claim 7, wherein the second insulation layer comprises an opaque material configured to convey heat across the second insulation layer or at least partially reflect solar irradiance.

9. The panel assembly of claim 7, wherein the material of the second insulation layer is configured to convey heat across the second insulation layer.

10. The panel assembly of claim 9, wherein the first insulation layer and the second insulation layer are collectively configured and dimensioned to surround a majority of an exterior surface of the phase change material.

11. The panel assembly of claim 1, further comprising a thermal management assembly adjacently disposed to the phase change material.

12. The panel assembly of claim 11, wherein the thermal management assembly comprises a thermoelectric cooler operable to at least partially remove latent heat stored within the phase change material.

13. The panel assembly of claim 11, further comprising a roof assembly adjacently disposed to the thermal management assembly.

14. The panel assembly of claim 13, wherein the roof assembly comprises a roof panel with a reflective material configured to at least partially reflect solar irradiance.

15. The panel assembly of claim 13, wherein the roof assembly comprises a material structured to convey long wave infrared radiation between the phase change material and the exterior.

16. The panel assembly of claim 1, wherein the panel assembly is provided within an individual one of a plurality of panel assemblies that collectively define an array.

17. The panel assembly of claim 16, wherein the array of panel assemblies is a component of a self-standing structure for thermal management.

18. The panel assembly of claim 17, wherein a support assembly of the self-standing structure comprises an upper frame structured to retain the array of panel members; and wherein the support assembly comprises a lower frame that is stationary or movable.

19. A panel assembly configured to at least partially extend over an area to be thermally managed, the panel member comprising:
a phase change material being operatively structured with an insulation assembly and being operable to absorb the conveyed heat thereby at least partially lowering the temperature of the area to be thermally managed; the insulation assembly comprising a first insulation layer and a second insulation layer collectively configured and dimensioned to at least partially insulate the phase change material;
a thermal management assembly comprising a thermoelectric cooler operatively configured with the phase change material and operable to at least partially remove latent heat stored within the phase change material; and
a roof assembly comprising a roof panel adjacently disposed to the thermal management assembly and configured to convey long wave infrared radiation between the phase change material and the exterior; and
wherein the first insulation layer comprises a material configured to allow conveyance of latent heat between the area to be thermally managed and the phase change material.
